(19) United States
(12) Patent Application Publication
(10) Pub. No.: US 2026/0209409 A1
(43) Pub. Date: Jul. 23, 2026

(54) PROPYLENE/ETHYLENE/1-BUTENE TERPOLYMER COMPOSITIONS WITH MULTIMODAL BASE POLYMER

(71) Applicant: BOREALIS AG, Vienna (AT)

(72) Inventors: Joel FAWAZ, Linz (AT); Jingbo WANG, Linz (AT); Markus GAHLEITNER, Linz (AT); Klaus BERNREITNER, Linz (AT); Pauli LESKINEN, Kulloo (FI)

(73) Assignee: BOREALIS AG, Vienna (AT)

(21) Appl. No.: 19/111,144

(22) PCT Filed: Sep. 20, 2023
(86) PCT No.: PCT/EP2023/075918

§ 371 Date: Mar. 12, 2025

(30) Foreign Application Priority Data
Sep. 21, 2022 (EP) 22196767.2

(51) Int. Cl. C08F 210/06; C08J 5/18

(52) U.S. Cl. CPC C08F 210/06; C08J 5/18; C08F 2800/10; C08J 2323/16

(57) ABSTRACT

A propylene/ethylene/1-butene terpolymer composition, includes a) a multimodal base polymer in an amount from 95 to 99.9 wt.-% relative to the total weight of the propylene/ethylene/1-butene terpolymer composition, with the following properties: i. a melt flow rate in the range from 3 to 12 g/10 min, as determined according to ISO 1133 at 230° C. at a load of 2.16 kg; ii. a content of 2,1-regiodefects in the range from 0.1 to 1.0 mol-%, as determined according to quantitative ¹³C-NMR spectroscopy analysis; iii. an ethylene content in the range from 1.0 to 4.0 mol-%, as determined according to ¹³C-NMR spectroscopy; and iv. a 1-butene content in the range from 3.0 to 10.0 mol-%, as determined according to ¹³C-NMR spectroscopy; v. a xylene cold soluble content in the range from 0 to 3.0 wt.-%, as determined according to ISO 16152. The multimodal base polymer includes a1) a first terpolymer fraction, in an amount of from 50 wt.-% to 80 wt.-% relative to the total weight of the multimodal base polymer, with a melt flow rate in the range from 1 to 10 g/10 min, as determined according to ISO 1133 at 230° C. at a load of 2.16 kg; and a2) a second terpolymer fraction, in an amount of from 20 wt.-% to 50 wt.-% relative to the total weight of the multimodal base polymer, with a melt flow rate in the range from 5 to 30 g/10 min, as determined according to ISO 1133 at 230° C. at a load of 2.16 kg; b) additives in an amount of from 0.1 to 5 wt.-% relative to the total weight of the propylene/ethylene/1-butene terpolymer composition selected from the group consisting only of antioxidants, anti-blocking agents, UV-stabilizers, anti-scratch agents, mold release agents, lubricants, anti-static agents, pigments, and mixtures thereof. The propylene/ethylene/1-butene terpolymer is essentially free of acid scavengers.

### FIELD OF THE INVENTION

The present invention pertains to a propylene/ethylene/1-butene terpolymer composition, and to a film, more particularly a cast film, comprising the mentioned propylene/ethylene/1-butene composition.

### BACKGROUND OF THE INVENTION

Packaging films based on propylene/ethylene/1-butene terpolymers are currently used in multilayered structures where each layer serves a different purpose. Films made of propylene/ethylene/1-butene terpolymers have been shown to be suitable as a sealing layer in such multilayered structures, for example as biaxially oriented polypropylene (BOPP) or cast films.

Different types of additives are added to base polymers prior to producing films in order to obtain desired properties and make them suitable for the end applications. Acid scavengers, or antiacids, are among one of the most common additives used in polymer industry (“Holzner, A. and Chmil, K. Chapter 4, “Acid Scavengers” in Plastics Additives Handbook, 6^{th} edition, Page 515-516.”). They are included in the additive mixture in order to reduce acidity of the polymer matrix which may occur as a result of the catalyst residues (for instance from Ziegler-Natta catalysts), or to indirectly influence crystallization behavior, or sometimes to act as a slipping agent (stearates exhibit such behavior). However, it is a common problem in the polymer design that sometimes they interact with antioxidants from the additive mixture leading to stability fluctuations, which then leads to a non-uniform film with varying properties along the thickness profile. In addition, stearates often tend to migrate to the surface when used as acid scavenger, making them less attractive for packaging applications.

U.S. Pat. No. 6,388,040 B1 pertains to metallocene catalyzed ethylene/propylene/C₄-C₂₀ alpha-olefin terpolymers wherein the total comonomer content ranges between 0.01 mol-% and 15 mol-% and the amount of 2,1 and 1,3-propylene units is in the range from 0 to 1 mol-%. The terpolymers disclosed herein are also characterized by a weight average molecular weight (Mw) ranging between 40,000 and 1,000,000 and the amount of the component eluted in o-dichlorobenzene at a temperature of not higher than 40° C. that is not more than 10% by weight based on the total weight of the terpolymer and the amount of the component eluted in o-dichlorobenzene within the +10° C. range of an elution peak temperature is not less than 75% by weight based on the weight of the component eluted at a temperature of higher than 0° C. However, terpolymers of U.S. Pat. No. 6,388,040 B1 are produced in a single reactor, meaning that they are not multimodal.

EP 2 173 471 B1 pertains to a process for producing a propylene terpolymer with comonomers of ethylene and C₄-C₈ alpha-olefin and a propylene terpolymer produced by such a process. The terpolymers of EP 2 173 471 B1 contain at least 8 wt.-% comonomer with respect to the total weight of the terpolymer. However, the terpolymers disclosed are produced using Ziegler-Natta catalyst.

U.S. Pat. No. 7,794,845 B2 discloses multilayer polypropylene films with a base layer A, skin layer B and a metal layer M deposited on the skin layer B, wherein the skin layer B is made of a polypropylene copolymer with a C₄-C₁₀ alpha-olefin in the amount ranging between 3 to 6 wt.-%. The base polymer used for the skin layer B is compounded with acid scavengers (hydrotalcite for inventive examples and Ca-stearate for comparative examples), among other additives.

Hence, it is the aim of the present invention to provide polypropylene terpolymers with good processability which are suitable for packaging applications. Such terpolymers should also be suitable for making a film having good sealing properties in terms of low sealing initiation temperature (SIT) and high Hot Tack Force (HTF), good optical properties in terms of low haze and high clarity, good mechanical properties, a uniform thickness profile over the film and stability in terms of extended oxygen induction time (OIT). All the balance of properties are aimed to be obtained with the polypropylene terpolymers according to the present invention without needing to include acid scavengers in the recipe.

The present invention achieves the above-mentioned goals with the propylene/ethylene/1-butene terpolymers described herein with multimodal polymer design having a certain level of 2,1-regiodefects and comonomer content.

### SUMMARY OF THE INVENTION

The present invention pertains to a propylene/ethylene/1-butene terpolymer composition, comprising
a) a multimodal base polymer (TP) in an amount from 95 to 99.9 wt.-% relative to the total weight of the propylene/ethylene/1-butene terpolymer composition, with the following properties:
   i. a melt flow rate (MFR₂) in the range from 3 to 12 g/10 min, as determined according to ISO 1133 at 230° C. at a load of 2.16 kg;
   ii. a content of 2,1-regiodefects in the range from 0.1 to 1.0 mol-%, as determined according to quantitative ¹³C-NMR spectroscopy analysis;
   iii. an ethylene content (C₂) in the range from 1.0 to 4.0 mol-%, as determined according to ¹³C-NMR spectroscopy; and
   iv. a 1-butene content (C₄) in the range from 3.0 to 10.0 mol-%, as determined according to ¹³C-NMR spectroscopy;
   v. a xylene cold soluble content (XCS) in the range from 0 to 3.0 wt.-%, as determined according to ISO 16152;
      wherein the multimodal base polymer (TP) comprises:
   a1) a first terpolymer fraction (TP1), in an amount of from 50 wt.-% to 80 wt.-% relative to the total weight of the multimodal base polymer (TP), with a melt flow rate (MFR₂) in the range from 1 to 10 g/10 min, as determined according to ISO 1133 at 230° C. at a load of 2.16 kg; and
   a2) a second terpolymer fraction (TP2), in an amount of from 20 wt.-% to 50 wt.-% relative to the total weight of the multimodal base polymer (TP), with a melt flow rate (MFR₂) in the range from 5 to 30 g/10 min, as determined according to ISO 1133 at 230° C. at a load of 2.16 kg;
b) additives in an amount of from 0.1 to 5 wt.-% relative to the total weight of the propylene/ethylene/1-butene terpolymer composition selected from the group consisting only of antioxidants, anti-blocking agents, UV-stabilizers, anti-scratch agents, mold release agents, lubricants, anti-static agents, pigments, and mixtures thereof;
   wherein the propylene/ethylene/1-butene terpolymer is essentially free of acid scavengers.

The present invention further pertains to a film, more preferably a cast film, comprising the propylene/ethylene/1-butene terpolymer composition disclosed herein.

### DETAILED DESCRIPTION

All the terms used herein is to be understood in their general meaning known to the skilled person in the art. In order to be more precise, the following terms will have the meaning as described hereinbelow.

A propylene terpolymer is a copolymer of propylene monomer units, wherein the copolymers are selected from ethylene and C₄-C₈ alpha olefins. A terpolymer typically comprises two or more different kinds of comonomer.

A multimodal polymer is a polymer having two or more fractions different from each other in at least one property, such as weight average molecular weight or comonomer content. The molecular weight distribution curve of such multimodal polymers (graph of polymer weight fraction vs. molecular weight) exhibit two or more maxima depending on the modality, or such curve is distinctly broadened in comparison with the curves of individual fractions. When the polymer contains two different fractions, it is called “bimodal”.

### 1) Propylene/Ethylene/1-Butene Terpolymer Composition

The propylene/ethylene/1-butene terpolymer composition according to the present invention comprises a multimodal base polymer (TP) in an amount of from 95 to 99.9 wt.-% relative to the total weight of the propylene/ethylene/1-butene terpolymer composition, and additives in an amount from 0.1 to 5 wt.-% relative to the total weight of the propylene/ethylene/1-butene terpolymer composition.

The propylene/ethylene/1-butene terpolymer composition preferably has a melt flow rate (MFR₂) measured according to ISO 1133 at 230° C. at a load of 2.16 kg from 1 to 20 g/10 min, more preferably from 5 to 15 g/10 min, and most preferably from 8 to 12 g/10 min.

The propylene/ethylene/1-butene terpolymer composition preferably has a crystallization enthalpy measured according to DSC analysis from 50 to 70 J/g, more preferably from 55 to 68 J/g, and most preferably from 60 to 65 J/g.

The propylene/ethylene/1-butene terpolymer composition preferably has a crystallization temperature measured according to DSC analysis from 70 to 95° C., more preferably from 75 to 92° C. and most preferably from 80 to 90° C.

The propylene/ethylene/1-butene terpolymer composition preferably has a heat of fusion measured according to DSC analysis from 55 to 75 J/g, more preferably from 60 to 73 J/g, and most preferably from 62 to 69 J/g.

The propylene/ethylene/1-butene terpolymer composition preferably has a melting point measured according to DSC analysis ranging from 110 to 135° C., more preferably from 115 to 130° C. and most preferably from 120 to 128° C.

The propylene/ethylene/1-butene terpolymer composition preferably has an oxygen induction time (OIT) measured at 180° C. according to ISO 11357-6 ranging from 10 to 30 minutes, more preferably from 15 to 28 minutes, and most preferably from 20 to 26 minutes.

The propylene/ethylene/1-butene terpolymer composition preferably has an oxygen induction time (OIT) measured at 190° C. according to ISO 11357-6 ranging from 3 to 20 minutes, more preferably from 5 to 15 minutes, and most preferably from 7 to 13 minutes.

### Multimodal Base Polymer (TP)

The multimodal base polymer (TP) according to the present invention is typically in the amount of from 95 to 99.9 wt.-%, preferably from 97 to 99.8 wt.-% relative to the total weight of the propylene/ethylene/1-butene terpolymer composition.

The multimodal base polymer (TP) comprises at least two fractions:
first terpolymer fraction (TP1), and
second terpolymer fraction (TP2).

In a preferred embodiment, the multimodal base polymer (TP) according to the present invention consists of the first (TP1) and the second (TP2) terpolymer fractions. In other words, it is preferred that the multimodal base polymer (TP) is bimodal.

The multimodal base polymer (TP) has a melt flow rate (MFR₂) measured according to ISO 1133 at 230° C. at a load of 2.16 kg in the range from 3 to 12 g/10 min, preferably from 5 to 9 g/10 min.

The multimodal base polymer (TP) has a content of 2,1-regiodefects in the range from 0.1 to 1.0 mol-%, preferably from 0.2 to 0.5 mol-% as determined according to quantitative ¹³C-NMR spectroscopy analysis.

The multimodal base polymer (TP) has an ethylene content (C₂) in the range from 1.0 to 4.0 mol-%, preferably from 1.5 to 3.5 mol-%, more preferably from 2.0 to 3.0 mol-%, and most preferably from 2.5 to 2.8 mol-%, as determined according to ¹³C-NMR spectroscopy.

The multimodal base polymer (TP) has a 1-butene content (C₄) in the range from 3.0 to 10.0 mol-%, preferably from 3.5 to 9.0 mol-%, more preferably from 4.0 to 8.0 mol-%, and most preferably from 4.5 to 7.0 mol-% as determined according to ¹³C-NMR spectroscopy.

The multimodal base polymer (TP) has a xylene cold soluble content (XCS) in the range from 0 to 3.0 wt.-%, preferably ranging from 1.0 to 2.8 wt.-%, and more preferably 1.5 to 2.5 wt.-%, as determined according to ISO 16152.

The multimodal base polymer (TP) preferably has an ethylene/1-butene ratio in the range from 0.1 to 0.9, more preferably from 0.2 to 0.7 and most preferably from 0.3 to 0.6, where the ratio is calculated dividing the ethylene amount in mol-% by the 1-butene amount in mol-%.

### First Terpolymer Fraction (TP1)

The first terpolymer fraction (TP1) is typically in an amount of from 50 to 80 wt.-%, preferably from 55 to 75 wt.-%, and most preferably from 58 to 70 wt.-%, relative to the total weight of the multimodal base polymer (TP).

The first terpolymer fraction (TP1) has a melt flow rate (MFR₂) in the range from 1 to 10 g/10 min, preferably from 2 to 8 g/10 min, and most preferably from 3 to 6 g/10 min, as determined according to ISO 1133 at 230° C. at a load of 2.16 kg.

The first terpolymer fraction (TP1) preferably has an ethylene content (C₂) in the range from 0.2 to 3.0 mol-%, more preferably from 0.5 to 2.0 mol-%, and most preferably from 0.8 to 1.5 mol-% as determined according to ¹³C-NMR spectroscopy.

The first terpolymer fraction (TP1) preferably has a 1-butene content (C₄) in the range from 2.0 to 7.0 mol-%, more preferably from 3.0 to 6.0 mol-%, and most preferably from 4.0 to 5.0 mol-% as determined according to ¹³C-NMR spectroscopy.

The first terpolymer fraction (TP1) preferably has a xylene cold soluble content (XCS) ranging from 0.1 to 5.0 wt.-%, more preferably from 0.3 to 3.0 wt.-%, and most preferably 0.5 to 1.0 wt.-%, as determined according to ISO 16152.

### Second Terpolymer Fraction (TP2)

The second terpolymer fraction (TP2) is typically in an amount of from 20 to 50 wt.-%, preferably from 25 to 45 wt.-%, and most preferably from 30 to 42 wt.-%, relative to the total weight of the multimodal base polymer (TP).

The second terpolymer fraction (TP2) has a melt flow rate (MFR₂) in the range from 5 to 30 g/10 min, preferably from 10 to 27 g/10 min, and most preferably from 15 to 23 g/10 min, as determined according to ISO 1133 at 230° C. at a load of 2.16 kg.

The second terpolymer fraction (TP2) preferably has an ethylene content (C₂) in the range from 3.0 to 7.5 mol-%, more preferably from 4.0 to 7.0 mol-%, and most preferably from 5.0 to 6.0 mol-% as determined according to ¹³C-NMR spectroscopy.

The second terpolymer fraction (TP2) preferably has a 1-butene content (C₄) in the range from 3.0 to 8.0 mol-%, more preferably from 4.0 to 7.0 mol-%, and most preferably from 5.0 to 6.5 mol-% as determined according to ¹³C-NMR spectroscopy.

### Additives

The propylene/ethylene/1-butene terpolymer composition further comprises additives, in an amount of from 0.1 to 5 wt.-%, preferably from 0.15 to 3 wt.-%, relative to the total weight of the propylene/ethylene/1-butene terpolymer composition.

The additives are selected from the group consisting only of antioxidants, anti-blocking agents, UV-stabilizers, anti-scratch agents, mold release agents, lubricants, anti-static agents, pigments, and mixtures thereof. Such additives are already widely known and well described, for instance in “Plastic Additives Handbook”, pages 871 to 873, 5th edition, 2001 of Hans Zweifel.

The propylene/ethylene/1-butene terpolymers are essentially free of acid scavengers. Acid scavengers, or antiacids, are among one of the most common additives used in polymer industry (“Holzner, A. and Chmil, K. Chapter 4, “Acid Scavengers” in Plastics Additives Handbook, 6^{th} edition, Page 515-516.”), and are used to reduce acidity of the polymer matrix. Presence of acid scavengers along with other additives, in particular with antioxidants often lead to stability fluctuations as it interacts with the antioxidants. Such fluctuations then lead to a non-uniform film with varying properties along the thickness profile. Examples of acid scavengers include calcium stearate (commercially available as “Ceasit” by Baerlocher GmbH, CAS no: 1592-23-0), zinc stearate (commercially available as “Zincum” by Baerlocher GmbH, CAS no: 557-05-1), magnesium oxide (CAS no: 1309-48-4), synthetic hydrotalcite (SHT, commercially available as “DHT 4A” or “DHT-4C” by Kisuma/Kyowa, CAS no: 11097-59-9).

It is then preferred that the additives are selected from the group consisting only of one or more antioxidants and anti-blocking agents.

Antioxidants can be any antioxidant that is already known to the skilled person in the art. For instance, it can be selected from a group consisting of:
sterically hindered phenols (“Phenolic AO”), such as 2,6-di-tert. butyl-4-methyl phenol (commercially available as “Ionol CP” by Raschig, CAS no: 128-37-0), pentaerythrityl-tetrakis (3-(3′,5′-di-tert. butyl-4-hydroxyphenyl)-propionate (commercially available as “Irganox 1010” by BASF, or as “Kinox 10 G” by HPL Additives, CAS no: 6683-19-8), octadecyl 3-(3′,5′-di-tert. butyl-4-hydroxyphenyl) propionate (commercially available as “Irganox 1076” by BASF, CAS no: 2082-79-3), 1,3,5-tri-methyl-2,4,6-tris-(3,5-di-tert. butyl-4-hydroxyphenyl)benzene (commercially available as “Irganox 1330” by BASF, CAS no: 1709-70-2), calcium (3,5-di-tert. butyl-4-hydroxy benzyl monoethyl-phosphonate) (commercially available as “Irganox 1425” by BASF, CAS no: 65140-91-2), 1,3,5-Tris (3′,5′-di-tert. butyl-4′-hydroxybenzyl)-isocyanurate (commercially available as “Irganox 3114” by BASF, CAS no: 27676-62-6);
phosphorous-based, such as tris(2,4-di-t-butylphenyl) phosphite (commercially available as “Irgafos 168 FF” by BASF, CAS no: 31570-04-4), tetrakis-(2,4-di-t-butylphenyl)-4,4′-biphenylen-di-phosphonite (commercially available as “Hostanox P-EPQ” by Clariant, CAS no: 38613-77-3);
alkyl radical scavengers;
sulphur-based, such as di-stearyl-thio-di-propionate (commercially available as “Irganox PS-802” by BASF, CAS no: 693-36-7), di-lauryl-thio-di-propionate (commercially available as “Irganox PS-800” by BASF, CAS no: 123-28-4);
aromatic amines;
hindered amine stabilizers
   and mixtures thereof.

Anti-blocking agents can be any anti-blocking agents that is already known to the skilled person in the art. For instance, it can be selected from a group consisting of natural silica, synthetic silica (commercially available as “Gasil AB 725” by PQ Corporation, CAS no: 7631-86-9), silicates such as sodium calcium aluminosilicate, hydrate (commercially available as “Siltom JC-30” by Mizusawa Ind. Chem.) and mixtures thereof.

The propylene/ethylene/1-butene terpolymer composition preferably has an antioxidant level less than 0.3 wt.-%, more preferably from 0.05 to 0.25 wt.-%, and most preferably from 0.08 to 0.2 wt.-% relative to the total weight of the propylene/ethylene/1-butene terpolymer composition.

### 2) Production of the Multimodal Propylene/Ethylene/1-Butene Terpolymer Composition

The multimodal propylene/ethylene/1-butene terpolymer composition is preferably produced according to a process with the steps as below:
a) mixing multimodal base polymer (TP) as described herein and the additives in an intensive mixer, and
b) compounding the mentioned ingredients in a co-rotating twin screw extruder.

### Process for the Multimodal Base Polymer (TP)

The multimodal base polymer (TP) according to the present invention is polymerized according to a process, having the following steps:
a) polymerizing propylene, ethylene and 1-butene comonomer units in a first reactor in the presence of a single-site catalyst (SSc) to produce a first terpolymer fraction (TP1),
b) transferring the product of the first reactor to a second reactor,
c) polymerizing propylene, ethylene and 1-butene comonomer units in the second reactor in the presence of the mentioned single-site catalyst (SSc) to produce a mixture comprising the first terpolymer fraction (TP1) and the second terpolymer fraction (TP2); and
d) withdrawing the mentioned mixture comprising the first terpolymer fraction (TP1) and second terpolymer fraction (TP2).

In a preferred embodiment, pre-polymerization is conducted prior to the polymerization as given in step a). In this optional step, propylene, ethylene and 1-butene is pre-polymerized in the presence of a single-site catalyst (SSc).

The first reactor is preferably a slurry reactor, more preferably a loop reactor, while the second reactor is preferably a gas phase reactor. Such a method including multi-step polymerization is developed by Borealis A/S, Denmark (known as Borstar® technology) and well-described in the patent literature, for instance in WO92/12182 or in EP-A-0887379.

The operating temperature of the first reactor preferably ranges between 55 and 85° C., while the pressure preferably ranges between 20 to 80 bar. In the second reactor, on the other hand, the temperature preferably ranges between 70 to 100° C., while the pressure preferably ranges between 10 to 50 bar.

It is also preferred that hydrogen is used as a chain control agent in at least one, or in both of the reactors, which then controls the molecular weight of the fractions produced in the mentioned reactors, which leads to the control of the melt flow rate.

### Catalyst

The single site catalyst (SSc) according to the present invention may be any supported metallocene catalyst suitable for the production of isotactic polypropylene. It is preferred that the single site catalyst (SSc) comprises a metallocene complex, a co-catalyst system comprising a boron-containing co-catalyst and/or aluminoxane co-catalyst, and a silica support.

In particular, it is preferred that the single site catalyst (SSc) comprises
(i) a metallocene complex of the general formula (I)

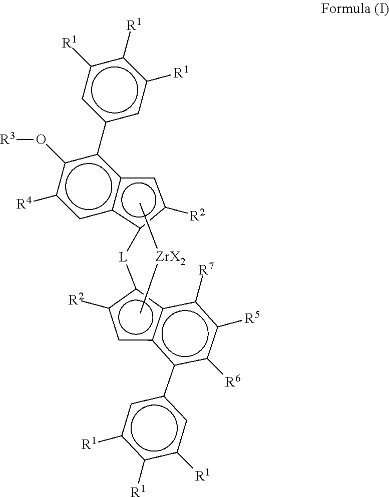

wherein each X independently is a sigma-donor ligand, L is a divalent bridge selected from —R′2C-, -R′2C-CR′2-, —R′2Si—, —R′2Si—SiR′2-, —R′2Ge—, wherein each R′ is independently a hydrogen atom or a C1-C₂₀-hydrocarbyl group optionally containing one or more heteroatoms from groups 14-16 of the periodic table or fluorine atoms, or optionally two R′ groups taken together can form a ring,
each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R1 groups can be part of a ring including the phenyl carbons to which they are bonded, each R2 independently are the same or can be different and are a CH₂—R⁸ group, with R⁸ being H or linear or branched C₁₋₆-alkyl group, C₃₋₈-cycloalkyl group, C₆₋₁₀-aryl group,
R³ is a linear or branched C₁-C₆-alkyl group, C₇₋₂₀-arylalkyl, C₇₋₂₀-alkylaryl group or C₆-C₂₀ aryl group,
R⁴ is a C(R⁹)₃ group, with R⁹ being a linear or branched C₁-C₆-alkyl group,
R⁵ is hydrogen or an aliphatic C₁-C₂₀-hydrocarbyl group optionally containing one or more heteroatoms from groups 14-16 of the periodic table;
R⁶ is hydrogen or an aliphatic C₁-C₂₀-hydrocarbyl group optionally containing one or more heteroatoms from groups 14-16 of the periodic table; or
R⁵ and R⁶ can be taken together to form a 5 membered saturated carbon ring which is optionally substituted by n groups R¹⁰, n being from 0 to 4;
each R¹⁰ is same or different and may be a C₁-C₂₀-hydrocarbyl group, or a C₁-C₂₀-hydrocarbyl group optionally containing one or more heteroatoms belonging to groups 14-16 of the periodic table;
R⁷ is H or a linear or branched C₁-C₆-alkyl group or an aryl or heteroaryl group having 6 to 20 carbon atoms optionally substituted by one to three groups R¹¹, each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group,
(ii) a co-catalyst system comprising a boron containing co-catalyst and/or an aluminoxane co-catalyst, and
(iii) a silica support.

The term “sigma-donor ligand” is well understood by the person skilled in the art, i.e. a group bound to the metal via a sigma bond. Thus the anionic ligands “X” can independently be halogen or be selected from the group consisting of R′, OR′, SiR′₃, OSiR′₃, OSO₂CF₃, OCOR′, SR′, NR′₂ or PR′₂ group wherein R′ is independently hydrogen, a linear or branched, cyclic or acyclic, C₁ to C₂₀ alkyl, C₂ to C₂₀ alkenyl, C₂ to C₂₀ alkynyl, C₃ to C₁₂ cycloalkyl, C₆ to C₂₀ aryl, C₇ to C₂₀ arylalkyl, C₇ to C₂₀ alkylaryl, C₈ to C₂₀ arylalkenyl, in which the R′ group can optionally contain one or more heteroatoms belonging to groups 14 to 16. In a preferred embodiment the anionic ligands “X” are identical and either halogen, like Cl, or methyl or benzyl.

A preferred monovalent anionic ligand is halogen, in particular chlorine (Cl).

Preferred complexes of the metallocene catalyst include:
rac-dimethylsilanediylbis [2-methyl-4-(3′,5′-dimethylphenyl)-5-methoxy-6-tert-butylinden-1-yl] zirconium dichloride,
rac-anti-dimethylsilanediyl [2-methyl-4-(4′-tert-butylphenyl)-inden-1-yl][2-methyl-4-(4′-tertbutylphenyl)-
5-methoxy-6-tert-butylinden-1-yl] zirconium dichloride,
rac-anti-dimethylsilanediyl [2-methyl-4-(4′-tert-butylphenyl)-inden-1-yl][2-methyl-4-phenyl-5-methoxy-6-tert-butylinden-1-yl] zirconium dichloride,
rac-anti-dimethylsilanediyl [2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl [2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl] zirconium dichloride,
rac-anti-dimethylsilanediyl [2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl] zirconium dichloride,
rac-anti-dimethylsilanediyl [2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl] zirconium dichloride.

Especially preferred is rac-anti-dimethylsilanediyl [2-methyl-4,8-bis-(3′,5′-dimethylphenyl)-1,5,6,7-tetrahydro-s indacen-1-yl][2-methyl-4-(3′,5′-dimethylphenyl)-5-methoxy-6-tert-butylinden-1-yl] zirconium dichloride.

The ligands required to form the complexes and hence catalysts of the invention can be synthesized by any process and the skilled organic chemist would be able to devise various synthetic protocols for the manufacture of the necessary ligand materials. For Example WO2007/116034 discloses the necessary chemistry. Synthetic protocols can also generally be found in WO 2002/02576, WO 2011/135004, WO 2012/084961, WO 2012/001052, WO 2011/076780, WO 2015/158790 and WO 2018/122134. Especially reference is made to WO 2019/179959, in which the most preferred catalyst of the present invention is described.

### Cocatalyst

To form an active catalytic species it is normally necessary to employ a cocatalyst as is well known in the art.

According to the present invention a co-catalyst system comprising a boron containing co-catalyst and/or an aluminoxane co-catalyst is used in combination with the above defined metallocene catalyst complex.

The aluminoxane co-catalyst can be one of formula (II):

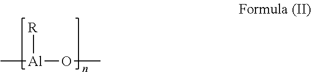

where n is usually from 6 to 20 and R has the meaning below.

Aluminoxanes are formed on partial hydrolysis of organoaluminum compounds, for example those of the formula AIR₃, AIR₂Y and Al₂R₃Y₃ where R can be, for example, C₁-C₁₀ alkyl, preferably C₁-C₅ alkyl, or C₃-C₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy.

The resulting oxygen-containing aluminoxanes are not in general pure compounds but mixtures of oligomers of the formula (II).

The preferred aluminoxane is methylaluminoxane (MAO). Since the aluminoxanes used as co-catalysts according to the invention are not, owing to their mode of preparation, pure compounds, the molarity of aluminoxane solutions hereinafter is based on their aluminium content.

According to the present invention, also a boron containing co-catalyst can be used instead of the aluminoxane co-catalyst or the aluminoxane co-catalyst can be used in combination with a boron containing co-catalyst.

It will be appreciated by the person skilled in the art that where boron based co-catalysts are employed, it is normal to pre-alkylate the complex by reaction thereof with an aluminium alkyl compound, such as TIBA. This procedure is well known and any suitable aluminium alkyl, e.g. Al(C₁-C₆ alkyl)₃ can be used. Preferred aluminium alkyl compounds are triethylaluminium, tri-isobutylaluminium, tri-isohexylaluminium, tri-n-octylaluminium and tri-isooctylaluminium.

Alternatively, when a borate co-catalyst is used, the metallocene catalyst complex is in its alkylated version, that is for example a dimethyl or dibenzyl metallocene catalyst complex can be used.

Boron based co-catalysts of interest include those of formula (III)

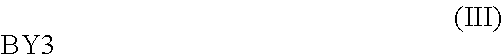

wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred options are trifluoroborane, triphenylborane, tris(4-fluorophenyl) borane, tris(3,5-difluorophenyl) borane, tris(4-fluoromethylphenyl) borane, tris(2,4,6-trifluorophenyl) borane, tris(penta-fluorophenyl) borane, tris(tolyl) borane, tris(3,5-dimethyl-phenyl) borane, tris(3,5-difluorophenyl) borane and/or tris(3,4,5-trifluorophenyl) borane.

Particular preference is given to tris(pentafluorophenyl) borane.

However it is preferred that borates are used, i.e. compounds containing a borate 3+ ion. Such ionic co-catalysts preferably contain a non-coordinating anion such as tetrakis(pentafluorophenyl) borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

It has been surprisingly found that certain boron co-catalysts are especially preferred. Preferred borates of use in the invention therefore comprise the trityl ion. Thus the use of N,N-dimethylammonium-tetrakispentafluorophenylborate and Ph₃CB(PhF₅)₄ and analogues therefore are especially favoured.

The preferred co-catalysts are aluminoxanes, more preferably methylaluminoxanes, combinations of aluminoxanes with Al-alkyls, boron or borate co-catalysts, and combination of aluminoxanes with boron-based co-catalysts.

The catalyst system of the invention is used in supported form. The particulate support material used is silica or a mixed oxide such as silica-alumina, in particular silica. The use of a silica support is preferred. The skilled practitioner is aware of the procedures required to support a metallocene catalyst.

In a preferred embodiment, the catalyst system corresponds to the ICS3 of WO 2020/239598 A1.

### 3) Film

The present invention further pertains to a film comprising the propylene/ethylene/1-terpolymer composition, preferably in an amount of at least 80 wt.-%, more preferably in an amount of at least 90 wt.-%, and more preferably in an amount of at least 95 wt.-%. It is the most preferred that the film consists of the propylene/ethylene/1-terpolymer composition.

The film according to the present invention is preferably a cast film. The cast film preferably has a thickness ranging from 5 to 100 μm, more preferably from 10 to 80 μm, and most preferably from 20 to 60 μm.

The film, more preferably cast film, preferably has a sealing initiation temperature (SIT) preferably from 100 to 115° C., more preferably from 101 to 110° C., and most preferably from 102 to 108° C., measured on a 50 μm cast film according to the method described herein in the “Measuring methods” section.

The film, more preferably cast film, preferably has a Hot Tack force determined according to ASTM F1921-12-Method B on a 50 μm cast film ranging from 1.0 to 5.0 N, more preferably from 1.5 to 4.0 N, and most preferably from 2.4 to 3.5 N.

The film, more preferably cast film, preferably has a haze value determined on a 50 μm cast film according to ASTM D1003 ranging from 0 to 2.0%, more preferably from 0.1 to 1.0%, and most preferably from 0.2 to 0.65%.

The film, more preferably cast film, preferably has a clarity value determined on a 50 μm cast film according to ASTM D1003 ranging from 90 to 100%, more preferably from 92 to 100%, and most preferably from 94 to 100%.

The film, more preferably cast film, preferably has a tensile modulus in the machine direction (MD) measured according to ISO 527-3 on a 50 μm cast film ranging from 300 to 700 MPa, more preferably from 400 to 600 MPa, and most preferably from 450 to 550 MPa.

### EXAMPLES

### A. Measuring Methods

### A1-Quantification of Microstructure by NMR Spectroscopy

Quantitative nuclear-magnetic resonance (NMR) spectroscopy was used to quantify the comonomer content of the polymers and the amount of 2,1 regio defects.

Quantitative ¹³C {¹H} NMR spectra recorded in the molten-state using a Bruker Avance III 500 NMR spectrometer operating at 500.13 and 125.76 MHz for 1H and ¹³C respectively. All spectra were recorded using a ¹³C optimised 7 mm magic-angle spinning (MAS) probehead at 180° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed utilising the NOE at short recycle delays of 3 s {pollard04, klimke06} and the RS-HEPT decoupling scheme {fillip05,griffin07}. A total of 1024 (1k) transients were acquired per spectra.

Quantitative ¹³C {1H} NMR spectra were processed, integrated and relevant quantitative properties determined from the integrals. All chemical shifts are internally referenced to the methyl isotactic pentad (mmmm) at 21.85 ppm.

Characteristic signals corresponding to the incorporation of 1-butene were observed {brandolini01} and the comonomer content quantified.

The amount of isolated 1-butene incorporated in PBP sequences was quantified using the integral of the αB2 sites at 43.6 ppm accounting for the number of reporting sites per comonomer:

$$B = {I}_{α B 2} / 2$$

The amount of consecutively incorporated 1-butene in PBBP sequences was quantified using the integral of the ααB2B2 site at 40.5 ppm accounting for the number of reporting sites per comonomer:

$$BB = 2 * {I}_{αα B 2 B 2}$$

In presence of BB the value of B must be corrected for the influence of the αB2 sites resulting from BB:

$$B = ( {I}_{α B 2} / 2 ) - BB / 2$$

The total 1-butene content was calculated based on the sum of isolated and consecutively incorporated 1-butene:

$${B}_{total} = B + BB$$

Characteristic signals corresponding to the incorporation of ethylene were observed {brandolini01} and the comonomer content quantified.

The amount of isolated ethylene incorporated in PEP sequences was quantified using the integral of the Sββ sites at 24.3 ppm accounting for the number of reporting sites per comonomer:

$$E = {I}_{S ββ}$$

If characteristic signals corresponding to consecutive incorporation of ethylene in PEE sequence was observed the Sβδ site at 27.0 ppm was used for quantification:

$$EE = {I}_{S βδ}$$

Characteristic signals corresponding to regio defects were observed {resconi00}. The presence of isolated 2,1-erythro regio defects was indicated by the presence of the two methyl sites at 17.7 and 17.2 ppm, by the methylene site at 42.4 ppm and confirmed by other characteristic sites. The presence of 2,1 regio defect adjacent an ethylene unit was indicated by the two inequivalent Sαβ signals at 34.8 ppm and 34.4 ppm respectively and the Tγγ at 33.7 ppm.

The amount of isolated 2,1-erythro regio defects (P_{21e isolated}) was quantified using the integral of the methylene site at 42.4 ppm (Iₑ₉):

$${P}_{21 e isolated} = {I}_{e 9}$$

If present the amount of 2,1 regio defect adjacent to ethylene (PE₂₁) was quantified using the methine site at 33.7 ppm (I_{Tγγ}):

$${PE}_{21} = {I}_{T γγ}$$

The total ethylene content was then calculated based on the sum of ethylene from isolated, consecutively incorporated and adjacent to 2,1 regio defects:

$${E}_{total} = E + EE + {PE}_{21}$$

The amount of propene was quantified based on the Sαα methylene sites at 46.7 ppm including all additional propene units not covered by Sαα e.g. the factor 3*P_{21e isolated} accounts for the three missing propene units from isolated 2,1-erythro regio defects:

$${P}_{total} = {I}_{S αα} + 3 * {P}_{21 e isolated} + B + 05 * BB + E + 0.5 * EE + 2 * {PE}_{21}$$

The total mole fraction of 1-butene and ethylene in the polymer was then calculated as:

$$\begin{matrix}fB = {B}_{total} / ( {E}_{total} + {P}_{total} + {B}_{total} ) \\ fE = {E}_{total} / ( {E}_{total} + {P}_{total} + {B}_{total} )\end{matrix}$$

The mole percent comonomer incorporation was calculated from the mole fractions:

$$\begin{matrix}B [ mol \% ] = 100 * fB \\ E [ mol \% ] = 100 * fE\end{matrix}$$

The weight percent comonomer incorporation was calculated from the mole fractions:

$$B [ wt . - \% ] = 100 * ( fB * 56.11 ) / ( ( fE * 28.05 ) + ( fB * 56.11 ) + ( ( 1 - ( fE + fB ) ) * 42.08 ) )$$

$$E [ wt . - \% ] = 100 * ( fE * 28.05 ) / ( ( fE * 28.05 ) + ( fB * 56.11 ) + ( ( 1 - ( fE + fB ) ) * 42.08 ) )$$

The mole percent of isolated 2,1-erythro regio defects was quantified with respect to all propene:

$$[ 21 e ] mol \% = 100 * {P}_{21 e isolated} / {P}_{t otal}$$

The mole percent of 2,1 regio defects adjacent to ethylene was quantified with respect to all propene:

$$[ E 21 ] mol \% = 100 * {PE}_{21} / {P}_{total}$$

The total amount of 2,1 defects was quantified as following:

$$[ 21 ] mol \% = [ 21 e ] + [ E 21 ]$$

Characteristic signals corresponding to other types of regio defects (2,1-threo, 3,1 insertion) were not observed {resconi00}.

### LITERATURE (AS REFERRED TO ABOVE)

klimke06 Klimke, K., Parkinson, M., Piel, C., Kaminsky, W., Spiess, H. W., Wilhelm, M., Macromol. Chem. Phys. 2006; 207:382.
parkinson07 Parkinson, M., Klimke, K., Spiess, H. W., Wilhelm, M., Macromol. Chem. Phys. 2007; 208:2128.
pollard04 Pollard, M., Klimke, K., Graf, R., Spiess, H. W., Wilhelm, M., Sperber, O., Piel, C., Kaminsky, W., Macromolecules 2004; 37:813.
filip05 Filip, X., Tripon, C., Filip, C., J. Mag. Resn. 2005, 176, 239
griffin07 Griffin, J. M., Tripon, C., Samoson, A., Filip, C., and Brown, S. P., Mag. Res. in Chem. 2007 45, S1, S198.
castignolles09 Castignolles, P., Graf, R., Parkinson, M., Wilhelm, M., Gaborieau, M., Polymer 50 (2009) 2373.
resconi00 Resconi, L., Cavallo, L., Fait, A., Piemontesi, F., Chem. Rev. 2000, 100, 1253.
brandolini01 A. J. Brandolini, D. D. Hills, “NMR spectra of polymers and polymer additives”, Marcel Deker Inc., 2000

Calculation of comonomer content of the second terpolymer fraction (TP2):

$$\frac{C ( TP ) - w ( TP 1 ) \times C ( TP 1 )}{w ( TP 2 )} = C ( TP 2 ) \qquad ( I )$$

wherein
w(TP1) is the weight fraction [in wt.-%] of the first terpolymer fraction (TP1),
w(TP2) is the weight fraction [in wt.-%] of second terpolymer fraction (TP2),
C(TP1) is the comonomer content [in mol-%] of the first terpolymer fraction (TP1),
C(TP) is the comonomer content [in mol-%] of the multimodal base polymer (TP),
C(TP2) is the calculated comonomer content [in mol-%] of the second terpolymer fraction (TP2).

### A2—Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR₂ of polypropylene was determined at a temperature of 230° C. and a load of 2.16 kg.

Calculation of melt flow rate MFR₂ (230° C.) of the second terpolymer fraction (TP2):

$$MFR ( TP 2 ) = 10 [ \frac{log ( MFR ( TP ) ) - w ( TP 1 ) \times log ( MFR ( TP 1 ) )}{w ( TP 2 )} ] \qquad ( II )$$

wherein
w(TP1) is the weight fraction in [wt.-%] of the first terpolymer fraction (TP1),
w(TP2) is the weight fraction in [wt.-%] of second terpolymer fraction (TP2),
MFR(TP) is melt flow rate MFR₂ (230° C.) in [g/10 min] of the multimodal base polymer (TP),
MFR(TP1) is melt flow rate MFR₂ (230° C.) in [g/10 min] of the first terpolymer fraction (TP1),
MFR(TP2) is melt flow rate MFR₂ (230° C.) in [g/10 min] of the second terpolymer fraction (TP2).

### A3—the Xylene Cold Soluble Fraction at Room Temperature (XCS, Wt.-%)

The amount of the polymer soluble in xylene was determined at 25° C. according to ISO 16152; 5th edition; 2005 Jul. 1.

A4—DSC Analysis, Melting Temperature (Tₘ), Heat of Fusion (H_{f}), Crystallization Temperature (T_{c}) and Crystallization Enthalpy (H_{c})

The melting temperature (Tₘ), heat of fusion (H_{f}), crystallization enthalpy (H_{c}) and crystallization temperature (T_{c}) were measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C.

Crystallization temperature (T_{c}) and crystallization enthalpy (H_{c}) are determined from the cooling step, while melting temperature (Tₘ) and heat of fusion (H_{f}) are determined from the second heating step.

### A5—Oxidation Induction Time (OIT)

The oxidation induction time (OIT) at 180° C. and at 190° C. were determined with a TA Instrument Q20 according to ISO11357-6. Calibration of the instrument was performed with Indium and Tin, according to ISO 11357-1. The maximum error in temperature from calibration was less than 0.1 K. Each polymer sample (cylindrical geometry with a diameter of 5 mm and thickness of 1±0.1 mm prepared by compression moulding) with a weight of 10±2 mg was placed in an open aluminium crucible, heated from 25° C. to 180° C. (or 190° C.) at a rate of 20° C./min in nitrogen (>99.95 vol. % N2, <5 ppm O₂) with a gas flow rate of 50 mL/min, and allowed to rest for 5 min before the atmosphere was switched to pure oxygen (>99.95 vol. % O₂), also at a flow rate of 50 mL/min. The samples were maintained at constant temperature, and the exothermal heat associated with oxidation was recorded. The oxidation induction time was the time interval between the initiation of oxygen flow and the onset of the oxidative reaction. Each presented data point was the average of three independent measurements.

### A6—Optical Properties—Haze and Clarity

Haze and clarity were determined according to ASTM D1003 on cast films with a thickness of 50 μm produced on a monolayer cast film line with a melt temperature of 240° C. and a chill roll temperature of 20° C.

### A7—Tensile Modulus (TM)

Tensile Modulus in the machine direction (MD) was determined according to ISO 527-3 at 23° C. on cast films of 50 μm thickness produced on a monolayer cast film line with a melt temperature of 240° C. and a chill roll temperature of 20° C. Testing was performed at a crosshead speed of 1 mm/min.

### A8—Hot Tack Force (HTF)

Hot Tack Force was determined according to ASTM F1921-12-Method B on a J&B Hot-Tack Tester on a 50 μm thickness film produced on a monolayer cast film line at a melt temperature of 240° C. and a chill roll temperature of 20° C.

### Specimen Cutter:

A rotary drum cutter or a strip cutter is used to cut the specimens to a width of 25 mm (+0.5%).

### Testing Machine:

Seal bar length: 50 mm
Seal bar width: 5 mm
Seal bar shape: flat
Seal bar material: brass-nickel
Coating of sealing bars: NIPTEF®
Roughness of sealing bars: approx. 1 μm
Force measurement: Piezo electric force transducer
Temperature measurement: 2 separate heating systems

### Thickness-Measuring Device (Accuracies According to ISO 4593:1993):

Positionsanzeige (Heidenhain; Type: ND 280)
Messtaster (Heidenhain; Type: MT 1281)
   Measuring surfaces: plane/plane polished
   Diameter of each face: 6.5 mm

### Conditioning of Samples/Test Specimens:

All test specimens have to be prepared in standard atmospheres for conditioning and testing at 23° C. (±2° C.) and 50% (±10%) relative humidity.
Minimum conditioning time of test specimen in standard atmosphere before start testing: >16 h.
Minimum storage time between extrusion of film sample and start testing: >88 h.

### Specimen Preparation:

Specimen type: parallel cut stripes with 25 mm (width)×approx. 320 mm (length) taken over the whole width of sample.
Specimen orientation: Machine direction
Specimens (films) shall be free from dust, fingerprints, wrinkles, folds, shrivelling or other obvious imperfections. The edges of cut specimens shall be smooth and free from notches.

### Thickness Measurement:

The thickness of the test specimen is measured in the sealing area.

### Hot Tack—Sealing Process:

The test shall be carried out in the same atmospheric conditions as the conditioning.

The prepared specimen strip is sealed by applying pressure from two flat heated seal jaws (NIPTEF®, 5*50 mm) under defined conditions of temperature, contact time and pressure.

The specimen is folded between the sealing jaws with an automatic specimen folding device. Sealing jaws close and after the pre-set sealing time elapsed, the sealing jaws open and the heat seal is complete. The selected cooling time elapses and the lower sample clamp moves down. During pulling the specimen the force transducer, attached to the upper sample clamp, measures the force. Afterwards the failure mode is determined visually.

### Standard Test Conditions:

Sealing temperature (ambient −240° C.)
Sealing time (thickness <25 μm: 0.5 s; thickness ≥25 μm: 1 s)
Sealing pressure (0.15 N/mm²)
Delay time (0.2 s)
Clamp separation rate (200 mm/s)

Note: The values of the parameters are freely user-selectable.

Number of test specimens: at least 3 specimens per temperature.

In case the measured values at one temperature step show significant deviation make sure it is only an outlier and test one further specimen (the number of specimen should always be uneven but the total should not exceed 7 tested specimen), the outlier is allowed to be eliminated from the measurement-deviation caused by other reasons must be considered.
Temperature steps/interval: 5° C.↑
(2° C.↑ in case of sharp increase/decrease between two temperature steps)
Start measuring at two temperature steps below 0.2-0.3 N.
Stop measuring at failure mode burnthrough

It is also allowed to have one failure mode with burnthrough and two other failure modes-plus one additional temperature step

A typical hot tack curve may require 25 to 50 specimens of each material.

### Results

The output of this method is a hot tack curve. The interpretation of hot tack curves has always rested on the relationship between sealing force and sealing temperature.

Hot Tack: highest force with failure mode “peel”. Also allowed are two “peel” failure modes and any other failure mode (except burnthrough failure mode) when 3 specimens/temperature step are used.

Deviating from ASTM F1921-12 Chapter 9, the test is performed after a cooling time of 200 ms. The end of the measurement described in chapter 9.8 of ASTM F1921-12 (test stop after determination of the Hot Tack) is not considered. End of test is after thermal failure of the film. In addition to failure mode evaluations described in the standard, additional failure modes are used.

### A9—Sealing Initiation Temperature (SIT)

This method is used to determine the sealing window (sealing temperature range) of films. The procedure is similar to hot tack measurement, but in contrast to hot tack the sealing range applies to the strength of the seal after it had cooled (delay time of 30 s).
Sealing range=(Seal initiation temperature until Seal end temperature)

The determined results give the user a quantitatively useful indication of the strength of the sealed films and show the temperature range for optimal sealing.

The temperature interval is set by default to 5° C., but can be reduced to 1° C. when the curve shows a sharp increase or decrease in the force values between two temperature steps in order to represent a better curve profile.

Deviating from ASTM F1921-12, the test parameters sealing pressure, cooling time and test speed are modified. The determination of the force/temperature curve is continued until thermal failure of the film. In addition to failure mode evaluations described in the standard, additional failure modes are used.

To characterize the material, the measured values sealing range start temperature (SIT), temperature at max. force (MAX) and sealing range end temperature (SET) are also determined.

### Standard Conditions:

Conditioning time: >96 h
Sealing jaws dimension: 50×5 mm
Sealing jaws shape: flat
Sealing jaws coating: Niptef
Sealing temperature: ambient −240° C.
Sealing temperature interval: 5° C.
Sealing time: 1 sec
Delay time: 30 sec
Sealing pressure: 0.4 N/mm² (PE); 0.67 N/mm² (PP)
Grip separation rate: 42 mm/sec
Sealing initiation force: 5 N
Sample width: 25 mm

### Results

The output of this method is a sealing curve.

The lower limit (Sealing Initiation Temperature-SIT) is the sealing temperature at which a sealing force of 5 N is achieved.

### B. Examples

The catalyst used in the polymerization process for all examples was Anti-dimethylsilanediyl [2-methyl-4,8-di(3,5-dimethylphenyl)-1,5,6,7-tetrahydro-s-indacen-1-yl][2-methyl-4-(3,5-dimethylphenyl)-5-methoxy-6-tert-butylinden-1-yl] zirconium dichloride as disclosed in WO 5 2019/179959 A1 as MC-2. The supported metallocene catalyst was produced analogously to IE2 in WO 2019/179959 A1.

All examples given in the present application have been prepared using the multimodal base polymer (TP), whose polymerization conditions are given in Table 1 below. The polymer product taken at the end of process in loop reactor consists of the first terpolymer fraction (TP1), while the polymer product taken at the end of the process in gas phase reactor consists of both first (TP1) and second terpolymer fraction (TP2). Hence, the values given in “Loop reactor” section of Table 1 represent values for the first terpolymer fraction (TP1) and the values given in “Gas phase reactor” section represent values for both the first (TP1) and second terpolymer fraction (TP2), i.e. multimodal base polymer (TP). The individual values for the second terpolymer fraction (TP2) were then calculated using the method described above in “Measuring methods” section.

TABLE 1
Polymerization conditions of multimodal base polymer (TP)
Prepolymerization

| | | |
|---|---|---|
| Temperature | [° C.] | 20 |
| Pressure | [bar] | 51 |
| Residence time | [h] | 0.4 |

Loop reactor

| | | |
|---|---|---|
| Temperature | [° C.] | 65 |
| Pressure | [bar] | 52 |
| H2/C3 ratio | [mol/kmol] | 0.1 |
| C2/C3 ratio | [mol/kmol] | 19.2 |
| C4/C3 ratio | [mol/kmol] | 68.3 |
| C2 content | [mol-%] | 1.0 |
| C4 content | [mol-%] | 4.6 |
| C2/C4 | — | 0.22 |
| MFR₂ | [g/10 min] | 4.3 |
| XCS | [wt.-%] | 0.8 |
| split | [wt.-%] | 62 |

Gas phase reactor

| | | |
|---|---|---|
| Temperature | [° C.] | 80 |
| Pressure | [bar] | 24 |
| H2/C3 ratio | [mol/kmol] | 1.6 |
| C2/C3 ratio | [mol/kmol] | 79.8 |
| C4/C3 ratio | [mol/kmol] | 51.2 |
| C2 content | [mol-%] | 2.7 |
| C4 content | [mol-%] | 5.1 |
| C2/C4 | — | 0.53 |
| MFR₂ | [g/10 min] | 7.7 |
| XCS | [wt.-%] | 2.3 |
| split | [wt.-%] | 38 |

The calculated values for second terpolymer fraction (TP2) are as following:
MFR₂: 19.9 g/10 min
C2 content: 5.4 mol-%
C4 content: 5.9 mol-%
C2/C4:0.91

The amount of 2,1-regiodefects of the multimodal base polymer (TP) was determined as 0.3 mol-%.

The multimodal base polymer (TP) was then mixed with different additives in an intensive mixer and IE1, IE2, CE1 and CE2 were prepared in a co-rotating twin-screw extruder. Recipes are given in Table 2, where Antioxidant 1 (AO1) is Kinox 10 G (supplied by HPL Additives), Antioxidant 2 (AO2) is Irgafos 168 FF (supplied by BASF), Anti-blocking agent (AB) is Gasil AB 725 (supplied by PQ Corporation), acid scavenger 1 (AS1) is CEASIT-FI (supplied by Baerlocher) and acid scavenger 2 (AS2) is DHT-4A (supplied by Kisuma/Kyowa).

TABLE 2
Details of propylene/ethylene/1-butene terpolymer composition

| Component | | CE1 | CE2 | IE1 | IE2 |
|---|---|---|---|---|---|
| TP | [wt.-%] | 99.74 | 99.77 | 99.78 | 99.74 |
| AO1 | [wt.-%] | 0.06 | 0.06 | 0.06 | 0.08 |
| AB | [wt.-%] | 0.1 | 0.1 | 0.1 | 0.1 |
| AO2 | [wt.-%] | 0.06 | 0.06 | 0.06 | 0.08 |
| AS1 | [wt.-%] | — | 0.01 | — | — |
| AS2 | [wt.-%] | 0.04 | — | — | — |

The properties of the polymer compositions that were prepared according to the recipe given in Table 2 and of cast films prepared from such compositions are given in Table 3 below.

TABLE 3
Properties of polymer compositions

| Property | Unit | CE1 | CE2 | IE1 | IE2 |
|---|---|---|---|---|---|
| Crystallization | [J/g] | 63.8 | 63.8 | 63.6 | 63.7 |
| enthalpy | | | | | |
| Crystallization | [° C.] | 88.5 | 87.4 | 88.3 | 88.2 |
| temperature | | | | | |
| Heat of fusion | [J/g] | 67.7 | 66.8 | 67.3 | 66.9 |
| Melting point | [° C.] | 126 | 127 | 126 | 126 |
| OIT at 180° C. | [min] | 4.1 | 19.6 | 22.7 | 20.7 |
| OIT at 190° C. | [min] | 5 | 8.8 | 8.1 | 11.6 |
| MFR₂ | [g/10 min] | 9.6 | 9.9 | 11.6 | 9.4 |

Film properties, measured on 50 μm cast film

| | | | | | |
|---|---|---|---|---|---|
| Hot tack force | [N] | 2.69 | 2.38 | 3.02 | 2.51 |
| Sealing initiation | [° C.] | 106 | 106 | 102 | 107 |
| temperature | | | | | |
| Clarity | [%] | 99.1 | 99.2 | 99.3 | 99.3 |
| Haze | [%] | 0.69 | 0.88 | 0.56 | 0.44 |
| Tensile modulus (MD) | [MPa] | 448 | 447 | 454 | 460 |

It was found by the inventors that the polymers according to the present invention produced by single site catalyst do not require the addition of acid scavengers in the additive recipe. CE1 contains DHT4A as the acid scavenger which is commonly used in the target applications and was observed to reduce the OIT significantly. CE2 on the other hand contains Calcium Stearate as the acid scavenger which appears to have little to no influence on OIT; nevertheless, it would migrate to the surface of the film affecting the film properties such as adhesion to the metallized layer. The two inventive examples still provide desirable thermal properties despite the absence of acid scavengers, which is evident by the low SIT and high HTF, good mechanical properties which can be seen from the tensile modulus and good optical properties which can be seen from the low haze and high clarity. Hence, the recipes not containing acid scavengers appear to be performing even better when the polymer according to the present invention that was produced using single site catalyst is used, without negatively influencing the sealing properties such as hot tack force and sealing initiation temperature, optics and mechanical properties.

1. A propylene/ethylene/1-butene terpolymer composition, comprising
a) a multimodal base polymer in an amount from 95 to 99.9 wt.-% relative to the total weight of the propylene/ethylene/1-butene terpolymer composition, with the following properties:
i. a melt flow rate in the range from 3 to 12 g/10 min, as determined according to ISO 1133 at 230° C. at a load of 2.16 kg;
ii. a content of 2,1-regiodefects in the range from 0.1 to 1.0 mol-%, as determined according to quantitative ¹³C-NMR spectroscopy analysis;
iii. an ethylene content in the range from 1.0 to 4.0 mol-%, as determined according to ¹³C-NMR spectroscopy; and
iv. a 1-butene content in the range from 3.0 to 10.0 mol-%, as determined according to ¹³C-NMR spectroscopy;
v. a xylene cold soluble content in the range from 0 to 3.0 wt.-%, as determined according to ISO 16152;
wherein the multimodal base polymer comprises:
a1) a first terpolymer fraction, in an amount of from 50 wt.-% to 80 wt.-% relative to the total weight of the multimodal base polymer, with a melt flow rate in the range from 1 to 10 g/10 min, as determined according to ISO 1133 at 230° C. at a load of 2.16 kg; and
a2) a second terpolymer fraction, in an amount of from 20 wt.-% to 50 wt.-% relative to the total weight of the multimodal base polymer, with a melt flow rate in the range from 5 to 30 g/10 min, as determined according to ISO 1133 at 230° C. at a load of 2.16 kg;
b) additives in an amount of from 0.1 to 5 wt.-% relative to the total weight of the propylene/ethylene/1-butene terpolymer composition selected from the group consisting only of antioxidants, anti-blocking agents, UV-stabilizers, anti-scratch agents, mold release agents, lubricants, anti-static agents, pigments, and mixtures thereof;
wherein the propylene/ethylene/1-butene terpolymer is essentially free of acid scavengers.

2. The propylene/ethylene/1-butene terpolymer composition according to claim 1, wherein the additives are selected from the group consisting only of one or more antioxidants and anti-blocking agents.

3. The propylene/ethylene/1-butene terpolymer composition according to claim 1, having an antioxidant level of less than 0.3 wt.-%, relative to the total weight of the propylene/ethylene/1-butene terpolymer composition.

4. The propylene/ethylene/1-butene terpolymer composition according to claim 1, wherein the multimodal base polymer is bimodal.

5. The propylene/ethylene/1-butene terpolymer composition according to claim 1, wherein the multimodal base polymer has a content of 2,1-regiodefects in the range from 0.2 to 0.5 mol-%, as determined according to quantitative ¹³C-NMR spectroscopy analysis.

6. The propylene/ethylene/1-butene terpolymer composition according to claim 1, wherein the multimodal base polymer has
a) an ethylene content in the range from 1.5 to 3.5 mol-%, as determined according to ¹³C-NMR spectroscopy, and/or
b) a 1-butene content in the range from 3.5 to 9.0 mol-%, as determined according to ¹³C-NMR spectroscopy.

7. The propylene/ethylene/1-butene terpolymer composition according to claim 1, wherein the multimodal base polymer has an ethylene amount/1-butene amount ratio in the range from 0.1 to 0.9, where the ratio is calculated by dividing the ethylene amount in mol-% by the 1-butene amount in mol-%.

8. The propylene/ethylene/1-butene terpolymer composition according to claim 1, wherein the first terpolymer fraction has
a) an ethylene content in the range from 0.2 to 3.0 mol-%, as determined according to ¹³C-NMR spectroscopy; and/or
b) a 1-butene content in the range from 2.0 to 7.0 mol-%, as determined according to ¹³C-NMR spectroscopy.

9. The propylene/ethylene/1-butene terpolymer composition according to claim 1, wherein the second terpolymer fraction has
a) an ethylene content in the range from 3.0 to 7.5 mol as determined according to ¹³C-NMR spectroscopy; and/or
b) a 1-butene content in the range from 3.0 to 8.0 mol-%, as determined according to ¹³C-NMR spectroscopy.

10. The propylene/ethylene/1-butene terpolymer composition according to claim 1, having
a) an oxygen induction time measured at 180° C. according to ISO 11357-6 in the range from 10 to 30 minutes, and/or
b) an oxygen induction time measured at 190° C. according to ISO 11357-6 in the range from 3 to 20 minutes.

11. A film, preferably a cast film, comprising the propylene/ethylene/1-butene terpolymer composition according to claim 1.

12. The film, preferably cast film according to claim 11 having a sealing initiation temperature in the range from 100 to 115° C., measured on a 50 μm cast film according to the method described in the experimental section.

13. The film, preferably cast film according to claim 11 having a Hot Tack Force in the range from 1.0 to 5.0 N, measured on a 50 μm cast film according to ASTM F1921-12-Method B.

14. The film, more preferably cast film according to claim 11 having a haze value ranging from 0 to 2.0%, as determined on a 50 μm cast film according to ASTM D1003.

15. The film, more preferably cast film according to claim 11 having a tensile modulus in the machine direction ranging from 300 to 700 MPa, as measured according to ISO 527-3 on a 50 μm cast film.
